(19) United States
(12) Patent Application Publication
(10) Pub. No.: US 2020/0312487 A1
(43) Pub. Date: Oct. 1, 2020

(54) POWER CORD WITH THE FULL METAL JACKET

(71) Applicant: Charles H. Stahlman, Glenmont, NY (US)

(72) Inventor: Charles H. Stahlman, Glenmont, NY (US)

(21) Appl. No.: 16/364,562

(22) Filed: Mar. 26, 2019

(51) Int. Cl. H01B 7/22; H01B 7/04; H01B 7/282; F21S 4/10; F21V 23/00; F21V 23/06

(52) U.S. Cl. CPC H01B 7/226; H01B 7/04; H01B 7/2825; H01R 13/5205; F21V 23/001; F21V 23/06; F21S 4/10

(57) ABSTRACT

A metal-encased extension cord is disclosed herein. The extension cord may include a flexible cable having a plurality of electrical couplers, a first end, connected to one of the plurality of electrical couplers, a second end connected to one of the plurality of electrical couplers, an electrical conductor between the first end and the second end, an electrical insulator surrounding the electrical conductor, and a metallic sheath surrounding the electrical conductor. The metallic sheath may comprise a helically-wound, stainless-steel ribbon having interlocked ribbon edges.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the constructional features of insulated conductors or cables characterized by their form and more specifically relates to the protection of electrical cables against damage caused by wear, mechanical force or pressure by armoring using a metallic sheath.

### 2. Description of Related Art

Electrical extension cords are widely used in households, offices and in industry. In customary use, extension cords provide a convenient means for extending electrical service from a fixed wall outlet to an electrical device located some distance away from the outlet. A drawback exists in the prior art extension cords in that they often tangle and are susceptible to damage. An improved electrical extension-cord system overcoming these limitations would be valuable to many.

Prior attempts have been made to overcome the above-noted limitations. U.S. Pub. No. 15/533,039 to Skryplonek relates to a protecting device for an elongated flexible member and an elongated flexible member with a protecting device. The described protecting device for an elongated flexible member and an elongated flexible member with a protecting device includes a protecting device for an elongated flexible member, the protecting device acting as a protection against biting and chewing on the elongated flexible member and being placed on at least a part of the elongated flexible member, wherein the protecting device is a spring made of wire or an array of rings arranged coaxially on a connecting element, the pitch of the spring or the distance between adjacent rings being respectively in the range of 0.05 cm to 5 cm; and an elongated flexible member with a protecting device.

### BRIEF SUMMARY OF THE INVENTION

In view of the foregoing disadvantages inherent in the known constructional features of insulated conductors, including cables characterized by their form, the present disclosure provides a novel improved extension cord systems. The general purpose of the present disclosure, which will be described subsequently in greater detail, is to provide a metal-encased extension cord having increased resistance to mechanical damage, corrosion and tangling.

An extension cord is disclosed herein. The extension cord may include a flexible cable having a plurality of electrical couplers, a first end, connected to one of the plurality of electrical couplers, a second end connected to one of the plurality of electrical couplers, an electrical conductor between the first end and the second end, an electrical insulator surrounding the electrical conductor, and a metallic sheath surrounding the electrical conductor. The metallic sheath may comprise a helically-wound, stainless-steel ribbon having interlocked ribbon edges.

A method of making an extension cord is also disclosed herein. The method of making the extension cord may comprise the steps of: providing a flexible cable having a first end, a second end, an electrical conductor between the first end and the second end, the electrical conductor may have an electrical insulator surrounding the electrical conductor, a metallic sheath adapted to surrounding the electrical conductor, and may comprise a wound, stainless-steel ribbon may have interlocked ribbon edges; and a plurality of plugs, placing the metallic sheath around the electrical conductor, connecting one of the plurality of plugs to the first end, and connecting one of the plurality of plugs to the second end.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an improved extension cord system, constructed and operative according to the teachings of the present disclosure.

FIG. 1 is a front perspective view of an extension cord, according to an embodiment of the disclosure.

FIG. 2 is an exploded perspective view of a first end of the extension cord of FIG. 1, according to an embodiment of the present disclosure.

FIG. 3 is an exploded perspective view of a second end of the extension cord of FIG. 1, according to an embodiment of the present disclosure.

FIG. 7 is a perspective view of an alternate configuration of the second end of the extension cord of FIG. 1, according to another embodiment of the present disclosure.

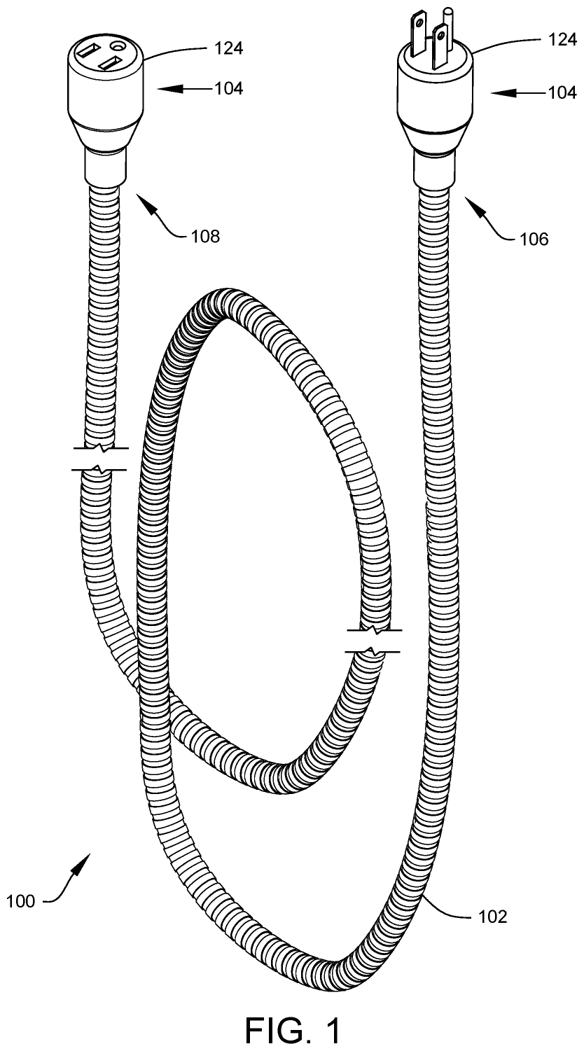

FIG. 4 is a transverse sectional view through one embodiment of the extension cord of FIG. 1, according to another embodiment of the present disclosure.

FIG. 5 is a sectional view through a metallic sheath of the extension cord of FIG. 1, according to an embodiment of the present disclosure.

FIG. 6 is a sectional view through an alternate metallic sheath of the extension cord of FIG. 1, according to another embodiment of the present disclosure.

FIG. 8 is a top view of an alternate configuration of the second end of the extension cord of FIG. 1, according to another embodiment of the present disclosure.

FIG. 9 is a perspective view of a kit containing the extension cord of FIG. 1, according to another embodiment of the present disclosure.

FIG. 10 is a front view of an extension cord having light-emitting elements, according to another embodiment of the disclosure.

FIG. 11 is a flow diagram illustrating a method of use for extension cord, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to the constructional features of insulated conductors or cables characterized by their form and more particularly to improved extension cord systems as used to improve the protection of electrical cables against damage caused by wear, mechanical force or pressure by armoring using a metallic sheath.

Generally, the disclosed system is an electrical extension cord useful to anyone from a contractor on a jobsite to a home user who needs to plug in a vacuum to clean their vehicle. The device of the present disclosure is used just as with any conventional extension cord; however, the present device has distinct advantage possessing a rugged tangle-free design. One problem that this electrical cord solves is that it eliminates the typical tangling found in existing cords nearly every time a conventional cord is used. Moreover, the presently-disclosed device eliminates the extra step a user has to take to re-loop the cord prior to its next used. There is no tangling with the improved design and no need to loop-up the device after use. It is also exceptionally durable. A user would have to purposely work at damaging the outer sheath of the presently-disclosed cord. It would not happen by accident as it can with regular extension cords. The presently-disclosed cord device is a stainless-steel-encased extension cord that includes a male plug end and may include a female plug end. The cord is essentially kink, puncture, tear, crack, thorn, nail, corrosion, rust and animal proof. The outer sheath is constructed from high-quality durable SAE 304 stainless steel that covers the inner conductive wires. The inner conductive wires may also be encased in a waterproof material for additional water protection. The improved device functions just as any other electrical extension cord would. No adapters or changes on the user's part is required. The construction of the device may include a male plug end, a female plug end (or end connectable to an electrical device), inside electrically-conductive wires, a first level of encasement around the wires, and an outer encasement surrounding the first level of encasement. The outer stainless-steel encasement may be formed into an accordion-like tubing sleeve. The outside diameter of the outer encasement may be about 16 mm; however, the size of the cord assembly may be larger or smaller depending on the size and quantity of wires needed to carry the desired amps, volts, watts, etc.

The disclosed device is different in that is the only cord out there that the user can throw device in a box or on the ground without the device becoming tangled. The device cannot be tangled in normal use. The use of the rugged metallic outer sheath saves the user from having to fix damaged areas with electrical tape. There is no extra step needed to untangle the cord before use, or to loop the cord back up after use. Despite these advantages, the device works the same as a conventional extension cord. It is both kink-proof and corrosion resistant. The device is rust proof and highly resistant to punctures, tears and cracking. Furthermore, the device is thorn and animal proof. The device always stays cool to the touch. The stainless steel outer sleeve is extremely durable, containing nickel and chromium, giving the material its corrosion-resistant properties. The cord device looks as good as new all year long. The stainless steel cord is completely impervious to the effects of Ultra-Violet (UV) radiation, which reflects the sun rays and does not absorb the UV components of the light. The strong, advanced flexible ridged design stays cool to the touch outdoors in the sun even extreme temperatures. The device is ultra-flexible and stronger than other cords while remaining lightweight. The solid outer metal coating is very sturdy but flexible, capable of going around sharp corners. The outside diameter of the outer sleeve may be supplied in a range of sizes to accommodate differing wire combinations. The system may utilize essentially any size wire in any size of the stainless steel outer jacket including, but not limited, to varying circumference and length.

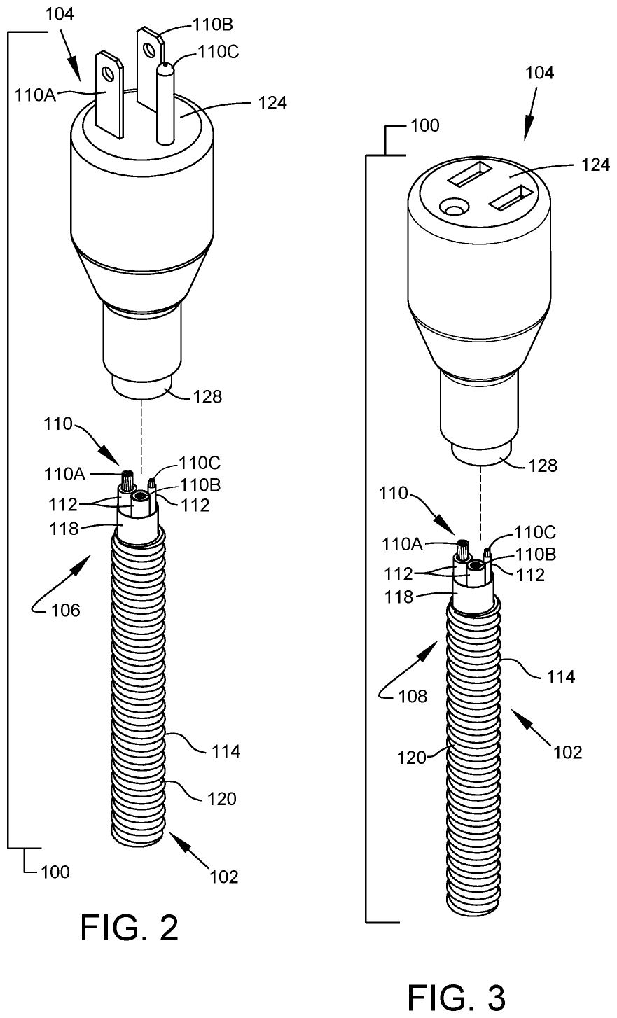

Referring now more specifically to the drawings by numerals of reference, there is shown in FIGS. 1-10, various views of an extension cord 100. FIG. 1 is a front perspective view of the extension cord 100, illustrating the rugged and tangle-free design of the device, according to an embodiment of the disclosure. As illustrated, the extension cord 100 may include a flexible cable 102 having a first end 106, a second end, and a set of electrical couplers 104 joined to the ends, as shown. The first end 106 may be connected to one electrical coupler 104 of the set, which in the presently-disclosed extension cord is a male-format plug 124 (see also FIG. 2). Similarly, the second end 108 may be connected to another electrical coupler 104 of the set, which in the presently-disclosed extension cord is a female-format plug receptacle 126 (see also FIG. 3). Each electrical coupler 104 of the set (at least embodying herein a plurality of electrical couplers) is configured to form an electrical connection with at least one electrical connection point, such as, for example, compatible male-format plugs, compatible female-format wall outlets, electrical devices, etc.

The set of electrical couplers 104 may be of any required format. Connection formats suitable for use with the presently-disclosed device may include, but are not limited to, U.S. and international formats A through N, trailer (and similar vehicle-specific) formats, military formats, custom formats, etc. Upon reading this specification, it should be appreciated that, under appropriate circumstances, considering such issues as user preferences, design preference, power requirements, marketing preferences, cost, available materials, technological advances, etc., other connector arrangements such as, for example, connectors providing combined power and data pathways, etc., may be sufficient.

FIG. 2 is an exploded perspective view of the first end 106 of the extension cord 100 of FIG. 1. FIG. 3 is an exploded perspective view of a second end of the extension cord of FIG. 1, according to an embodiment of the present disclosure. In the depictions of FIG. 2 and FIG. 3, the electrical couplers 104 have been separated from the first and second ends for clarity of description. It should be noted that, in preferred use, the selected electrical couplers 104 are firmly coupled to respective ends of the flexible cable 102, as shown in FIG. 1.

Referring to both FIG. 2 and FIG. 3, the internal construction of the flexible cable 102 may include one or more electrical conductors 110 extending between the first end 106 and the second end 108. Each of the electrical conductors 110 are configured to conduct electrical current between the electrical couplers 104 located at the first end 106 and the second end 108. The electrical conductors 110 may comprise stranded copper (Cu), stranded aluminum (Al) or combinations of both. The electrical conductors 110 may comprise wire sizes ranging between about 24 AWG and about 0000 AWG. In one embodiment of the present disclosure, the wire may be number 16 gauge stranded wire rated for 13 amps at 120 volts, which matches the wire sizing in many electrical cords sold in the United States. Upon reading this specification, it should be appreciated that, under appropriate circumstances, considering such issues as user preferences, intended use, design preference, electrical requirements, marketing preferences, cost, available materials, technological advances, etc., other conductor size arrangements such as, for example, smaller conductors for connecting micro-electronics, larger conductors for utility-scale applications needing a hardened electrical feed, etc., may be sufficient.

FIG. 4 is a transverse sectional view through the extension cord 100 of FIG. 1, according to another embodiment of the present disclosure. Although each flexible cable 102 includes at least one electrical conductor 110, embodiments of the present disclosure may include any required number of electrical conductors 110. In the depicted embodiments of the present disclosure, the flexible cable 102 includes three electrical conductors 110. The electrical conductors 110 may function as a hot conductor 110A (also referred to as an active conductor), a neutral conductor 110B, and an equipment-grounding conductor 110C (also referred to as an earth ground). Upon reading this specification, it should be appreciated that, under appropriate circumstances, considering such issues as user preferences, design preference, intended use, marketing preferences, cost, available materials, technological advances, etc., other conductor arrangements such as, for example, including conductor designed to carry data signals, etc., may be sufficient.

Each of the electrical conductors 110 may be surrounded by an electrical insulator 112 provided to electrically isolate individual conductors from the adjacent components of the flexible cable 102. The electrical insulator 112 may consist of one or more durable and flexible dielectric materials with resilient synthetic polymers being preferred. The electrical insulators 112 may be supplied in a color-coded format. For example, the insulator for the hot conductor 110A may be black, the insulator for the neutral conductor 1106 may be white, and the insulator for the equipment-grounding conductor 110C may be green.

A flexible outer metallic sheath 114 is provided to protectively surround the electrical conductors 110 and other internal elements of the flexible cable 102. In a preferred embodiment of the present disclosure, the outer metallic sheath 114 comprises a helically-wound, stainless-steel ribbon 120 having interlocked ribbon edges 116. Through experimentation, it was found that the use of an outer metallic sheath 114 of this configuration provides an increased level of durability along with an unexpected resistance to tangling.

FIG. 5 is a sectional view through the metallic sheath 114 of the extension cord of FIG. 1, according to an embodiment of the present disclosure. The flexible metallic sheath 114 is constructed from thin sheet-metal ribbons 120 that are convoluted and joined at their edges. Visible in FIG. 5 is the preferred interlocked ribbon edges 116 of the sheet-metal ribbons that form the outer metallic sheath 114. In particular, the sheet-metal bands are wound helically with their convolutions secured together by reversely-curved interlocking of the ribbon edges 116, as shown. In the depicted embodiment of FIG. 5, the interlocked ribbon edges 116 comprise a double interlocked configuration. Those with ordinary skill in the art will now appreciate that upon reading this specification, and by their understanding the art of metal forming and related production methods as described herein, methods of machine-forming interlocked ribbon edges will be understood by those knowledgeable in such art.

In one embodiment of the present disclosure, the continuous helically-wound stainless-steel ribbons 120 comprises SAE 304 stainless steel alloy. Thus, the stainless steel sheath is both corrosion resistant and is not damaged by prolonged exposure to Ultra-Violet (UV) radiation. Upon reading this specification, it should be appreciated that, under appropriate circumstances, considering such issues as user preferences, design preference, structural requirements, marketing preferences, cost, available materials, technological advances, etc., other material arrangements such as, for example, other stainless-steel alloys, aluminum alloys, other corrosion-resistant metals, plated steel, dipped (galvanized) steel, coated steel, rigid polymers, composite materials, etc., may be sufficient.

It is anticipated that some embodiments of the present disclosure may be configured to electrically couple the flexible metallic sheath 114 electrically to the equipment-grounding conductor 110C. This alternate configuration may provide an additional safety protection should the internal hot conductor 110A, or an external electrical source, come in contact with the outer metallic sheath 114.

Also visible in FIG. 5 is a waterproof sleeve 118 included in some embodiments of the present disclosure. The waterproof sleeve 118 is configured to surround and protect the electrical insulators 112 located within the outer metallic sheath 114. Such waterproof sleeves 118 may be constructed from a resilient synthetic polymer or similar flexible waterproof materials. The waterproof sleeve 118 may be configured to extend continuously between the first end 106 and the second end 108, as shown.

FIG. 6 is a sectional view through an alternate metallic sheath 114 of the extension cord of FIG. 1, according to another embodiment of the present disclosure. In this version, the waterproof sleeve 118 is formed into a continuous gasket 119 that is integrated within the interlocked ribbon edges of the outer metallic sheath 114, as shown. This annular packing seal maintains the flexibility of the outer assembly while preventing the migration of moisture through the metallic sheath 114.

Referring again to FIG. 2 and FIG. 3, the projecting pins of the male-format plug 124 and the receiving sockets of the female-format plug receptacle 126 may be formed from one or more rigid and electrically-conductive metallic materials. The supportive bodies of the male-format plug 124 and female-format plug receptacle 126 may be formed from one or more durable materials. More specifically, the supportive bodies of the male-format plug 124 and female-format plug receptacle 126 may be formed from one or more durable plastic materials, which may be formed by a molding process.

Both the male-format plug 124 and female-format plug receptacle 126 may be designed to be watertight. More specifically, both the male-format plug 124 and female-format plug receptacle 126 may be designed to prevent water from entering the interior of the waterproof sleeve 118. This may be accomplished by utilizing a liquid-tight fitting 128 positioned within or between the respective electrical couplers 104 and the corresponding open ends of the waterproof sleeve 118. Alternately, the electrical couplers 104 may be co-molded about the ends of the metallic sheath 114, thus forming a continuous barrier to prevent water from moving past the electrical couplers 104 into the interior of the waterproof sleeve 118. Upon reading this specification, it should be appreciated that, under appropriate circumstances, considering such issues as design preference, water-resistant requirements, cost, available materials, technological advances, etc., other waterproofing arrangements such as, for example, locating a waterproof sleeve on the outside of the metallic sheath, etc., may be sufficient. In some embodiments, the male- and female-format plugs comply with the NEMA 5 standard.

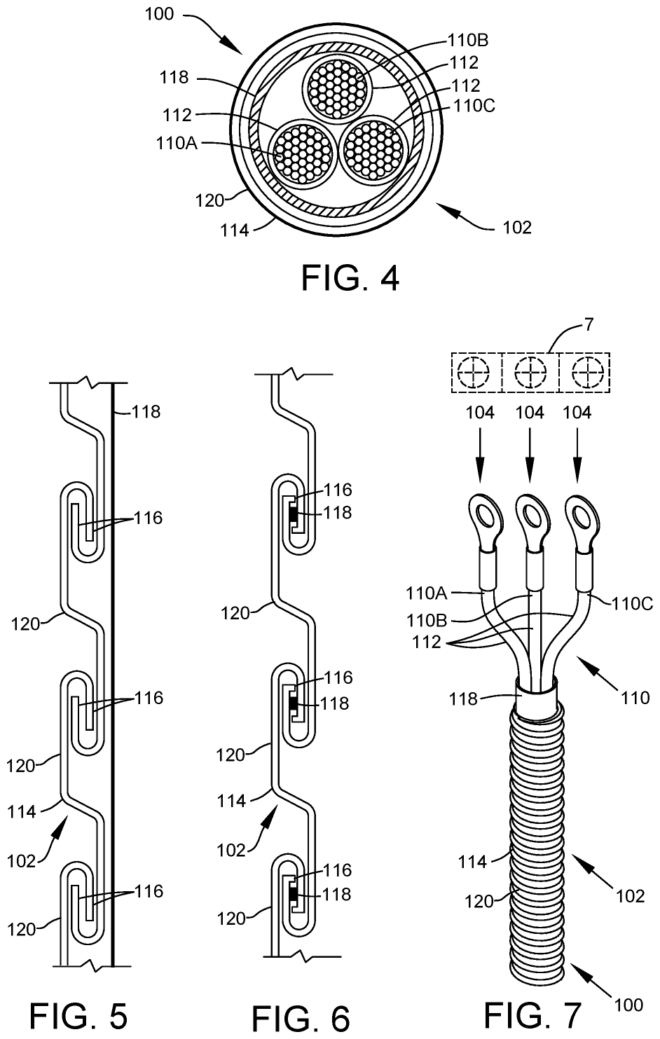

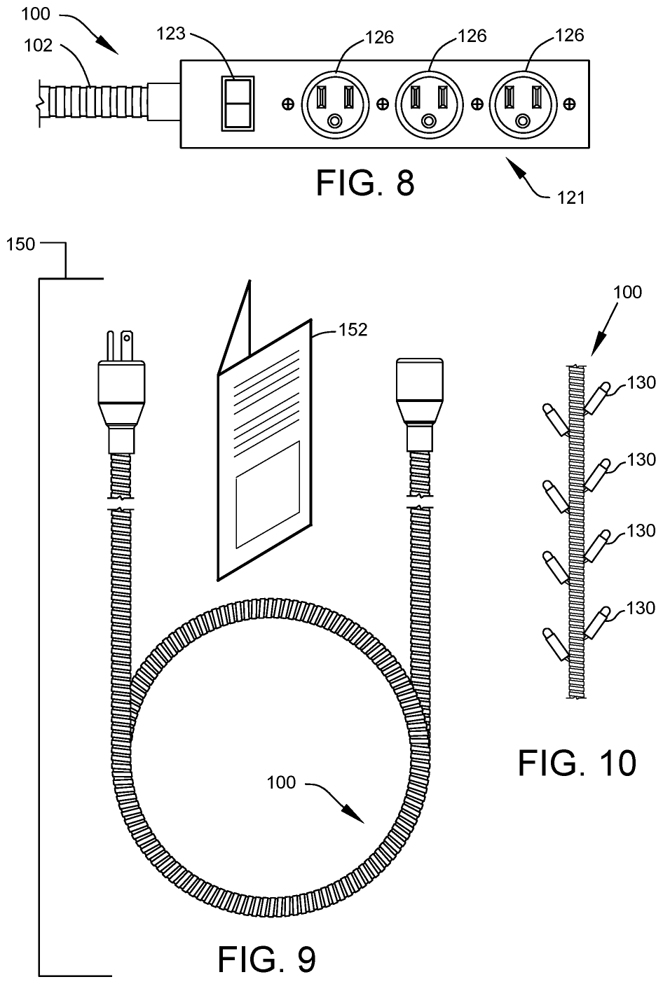

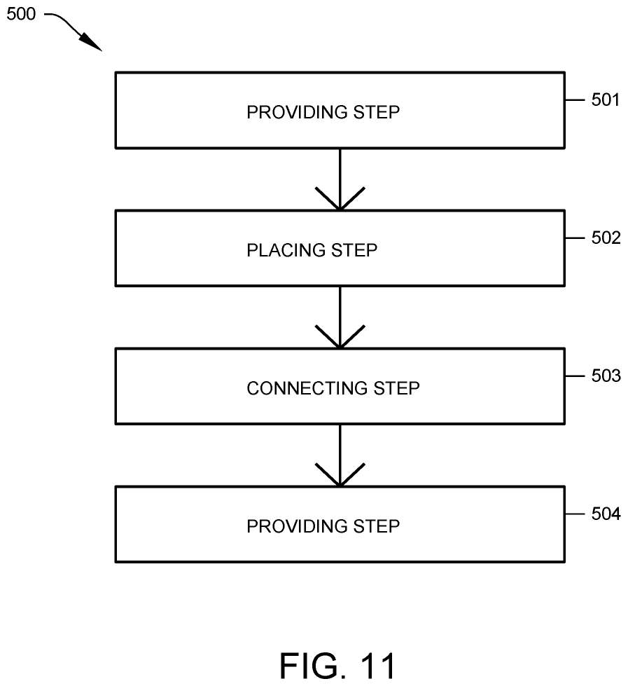

FIG. 7 is a perspective view of an alternate configuration of the second end 108 of the extension cord 100 of FIG. 1, according to another embodiment of the present disclosure. As above, the extension cord 100 may include electrical conductors 110, electrical insulators 112, a waterproof sleeve 118, and an outer metallic sheath 114. In the alternate embodiment of FIG. 7, the electrical conductors 110 are fitted with electrical couplers 104 designed to form a permanent or semi-permanent connection to an electrically-operated apparatus 7. Such terminating electrical couplers 104 may include spade-type lugs, hook-type lugs, or ring-type lugs, as shown. In this arrangement, the extension cord 100 may function as an appliance extension cord, also commonly referred to as a pigtail cord.

FIG. 8 is a top view of an alternate configuration of the second end 108 of the extension cord 100, according to another embodiment of the present disclosure. In this version, the second end 108 comprises a plurality of female-format plug receptacles 126, thus forming a power strip 121, as shown. Such a power strip may include a block of female-format plug receptacles 126 operably coupled to the second end 108 of the extension cord 100. The block of female-format plug receptacles 126 allows multiple electrical devices to be powered from a single electrical socket. This particular embodiment is especially useful when multiple electrical devices are in proximity, such as for audio, video, computer systems, appliances, power tools, lighting, etc. The device may include an on/off switch 123 and may further include an internal circuit breaker to interrupt the electric current in case of an overload or a short circuit.

FIG. 9 is a perspective view of a kit 150 containing the extension cord 100 of FIG. 1, according to another embodiment of the present disclosure. the kit 150 may include a set of instructions 152. The instructions 152 may detail functional relationships in relation to the structure of the extension cord 100 (such that the extension cord 100 can be used, maintained, or the like, in a preferred manner). Upon reading this specification, it should be appreciated that, under appropriate circumstances, considering such issues as design preference, intended use, cost, available materials, technological advances, etc., other kit arrangements such as, for example, providing a storage bag for the cord, providing a cord reel to hold the cord, including the cord with an electrically-operated device, providing country-specific adapters, etc., may be sufficient.

FIG. 10 is a front view of an extension cord 100 having light-emitting elements 130, according to another embodiment of the disclosure. In this version of the apparatus, the flexible cable 102 includes at least one light-emitting element 130, as shown. By way of example, the flexible cable 102 may include a plurality of light-emitting elements 130 in a spaced-apart arrangement, as shown. In this configuration, the apparatus may be used as a tangle-free set of holiday lights. Upon reading this specification, it should be appreciated that, under appropriate circumstances, considering such issues as user preferences, design preference, structural requirements, marketing preferences, cost, available materials, technological advances, etc., other illumination arrangements such as, for example, providing illuminated electrical couplers, etc., may be sufficient.

FIG. 11 is a flow diagram illustrating a method of making an extension cord 500, according to an embodiment of the present disclosure. As illustrated, the method 500 may include the steps of: step one, 501, providing, generally described above, a flexible cable having a first end a second end an electrical conductor between the first end and the second end, the electrical conductor having an electrical insulator surrounding the electrical conductor a metallic sheath adapted to surrounding the electrical conductor and comprising a wound, stainless-steel ribbon having interlocked ribbon edges; and a plurality of plugs; step two 502, placing the metallic sheath around the electrical conductor; step three, 503, connecting one of the plurality of plugs to the first end and connecting one of the plurality of plugs to the second end.

Even further, it provides such a method 500, further comprising the steps of: step four, 504, providing the one of the plurality of plugs connected to the first end in a male format; and providing the one of the plurality of plugs connected to the second end in a female format.

It should also be noted that the steps described in the above method can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for assembling the extension cord 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. An extension cord comprising:
a flexible cable having:
a plurality of electrical couplers;
a first end, connected to one of the plurality of electrical couplers;
a second end connected to one of the plurality of electrical couplers;
an electrical conductor between the first end and the second end;
an electrical insulator surrounding the electrical conductor; and
a metallic sheath surrounding the electrical conductor and comprising a wound, stainless-steel ribbon having interlocked ribbon edges.

2. The extension cord of claim 1, wherein the electrical insulator comprises a resilient polymer.

3. The extension cord of claim 1,further comprising a waterproof sleeve surrounding the electrical insulator.

4. The extension cord of claim 1, wherein the continuous helically wound stainless-steel ribbon comprises SAE 304 stainless steel alloy.

5. The extension cord of claim 1, wherein the interlocked ribbon edges comprise a double interlocked configuration.

6. The extension cord of claim 1, wherein the flexible cable comprises at least two electrical conductors.

7. The extension cord of claim 1, wherein the electrical conductor comprises a stranded metallic composition.

8. The extension cord of claim 1, further comprising at least one light-emitting element.

9. The extension cord of claim 1, wherein the electrical conductor has a wire size of between about 24 AWG and about 0000 AWG.

10. The extension cord of claim 1, further comprising a grounding conductor.

11. The extension cord of claim 11, wherein the outer metallic sheath is connected to the grounding conductor.

12. The extension cord of claim 1, wherein the electrical coupler connected to the first end is a male-format plug.

13. The extension cord of claim 1, wherein the electrical coupler connected to the second end is a female-format plug receptacle.

14. The extension cord of claim 1, wherein the electrical coupler connected to the second end comprises a plurality of female-format plug receptacles.

15. The extension cord of claim 1, wherein the electrical coupler connected to the second end is configured to be permanently-connectable to an electrically-operated apparatus.

16. The extension cord of claim 3, wherein the electrical coupler connected to the first end is joined to the waterproof sleeve with a liquid-tight fitting.

17. An extension cord comprising:
a flexible cable having:
a plurality of plugs;
a first end connected to one of the plurality of plugs;
a second end connect to one of the plurality of plugs;
an electrical conductor between the first end and the second end;
an electrical insulator surrounding the electrical conductor; and
a metallic sheath surrounding the electrical conductor and comprising a wound, stainless-steel ribbon having interlocked ribbon edges,
wherein the electrical insulator comprises a resilient polymer,
wherein the continuous helically-wound stainless-steel ribbon comprises SAE 304 stainless steel alloy,
wherein the interlocked ribbon edges comprise a double interlocked configuration,
wherein the flexible cable comprises at least two electrical conductors,
wherein the electrical conductor comprises at least one of a stranded copper (Cu) and a stranded aluminum (Al),
wherein the electrical conductor has a wire size of between about 24 AWG and about 0000,
wherein the plug connected to the first end comprises a male-format plug, and
wherein the plug connected to the second end comprises at least one female-format plug receptacle.

18. The extension cord of claim 17, further comprising a set of instructions and wherein the extension cord is arranged as a kit.

19. (canceled)

20. (canceled)
